(19) United States
(12) Patent Application Publication
(10) Pub. No.: US 2025/0307225 A1
(43) Pub. Date: Oct. 2, 2025

(54) WORK SUPPORT SYSTEM, WORK SUPPORT METHOD, AND INFORMATION STORAGE MEDIUM

(71) Applicant: Cybozu, Inc., Tokyo (JP)

(72) Inventors: Yoshiaki YAJIMA, Shiki-shi (JP); Tatsuya SASAKI, Shinshiro-shi (JP); Wataru IIJIMA, Kitamoto-shi (JP); Yuki NAKAJIMA, Tokyo (JP); Kazutoshi NAKANO, Saitama-shi (JP); Masaki TAKAHASHI, Setouchi-shi (JP)

(21) Appl. No.: 19/090,446

(22) Filed: Mar. 26, 2025

(30) Foreign Application Priority Data
Mar. 29, 2024 (JP) 2024-055511

(51) Int. Cl. G06F 16/22; G06F 16/23

(52) U.S. Cl. CPC G06F 16/2282; G06F 16/2365

(57) ABSTRACT

Provided is a work support system, which is configured to support work of a user through use of a database designed with no-code or low-code, the work support system including at least one processor configured to: acquire field information relating to each field of the database; execute, based on the field information and an AI, generation-related processing relating to generation of storage data to be stored in the database; and store the storage data in the database.

### CROSS-REFERENCE TO RELATED APPLICATION

The present disclosure contains subject matter related to that disclosed in Japanese Patent Application JP 2024-055511 filed in the Japan Patent Office on Mar. 29, 2024, the entire contents of which are hereby incorporated by reference.

### BACKGROUND OF THE INVENTION

### 1. Field of the Invention

The present disclosure relates to a work support system, a work support method, and an information storage medium.

### 2. Description of the Related Art

Hitherto, there known technologies capable of supporting work of users through use of a database designed with no-code or low-code. For example, in Japanese Patent Application Laid-open No. 2002-358305, there is described a data processing device which stores, in association with each item of a database, dummy designation information for replacing data of the each item by dummy data, registers processing for data in each item of the database, determines whether or not dummy designation is set for data of an item to be processed in the database based on the dummy designation information, and replaces, when it is determined that dummy designation is set for data of an item to be processed in the database, the data of the item by the dummy data, and displays a result of the processing for the replaced dummy data.

For example, in Japanese Patent Translation Publication No. 2014-511587, there is described a method including: storing, in a data storage system, at least one dataset including a plurality of records; and processing, in a data processing system coupled to the data storage system, multiple records of the plurality of records to produce codes representing data patterns in the multiple records. In this method, for each of the multiple records in the plurality of records, a code encoding one or two or more elements is associated with the record, each element represents a state or property of a corresponding field or combination of fields as one of a set of element values, and for at least one element of at least a first code, the number of element values in the set is smaller than the total number of data values that occur in the corresponding field or combination of fields over all the plurality of records in the dataset.

However, the technology of Japanese Patent Application Laid-open No. 2002-358305 is merely a technology for replacing data already stored in a database by dummy data, and hence a user is required to provide original data to be converted into the dummy data. In the technology of Japanese Patent Translation Publication No. 2014-511587, code representing a data pattern in a record of a database can be generated, but the data pattern cannot be identified unless the record is stored in the database in advance. The technologies of Japanese Patent Application Laid-open No. 2002-358305 and Japanese Patent Translation Publication No. 2014-511587 require a user to take time and labor to provide data in advance, and thus have not been able to sufficiently increase convenience of the user.

### SUMMARY OF THE INVENTION

One object of the present disclosure is to increase convenience of a user.

According to at least one aspect of the present disclosure, there is provided a work support system, which is configured to support work of a user through use of a database designed with no-code or low-code, the work support system including at least one processor configured to: acquire field information relating to each field of the database; execute, based on the field information and an AI, generation-related processing relating to generation of storage data to be stored in the database; and store the storage data in the database.

### BRIEF DESCRIPTION OF THE DRAWINGS

FIG. 1 is a diagram for illustrating an example of a hardware configuration of a work support system.

FIG. 2 is a view for illustrating an example of a work support screen displayed on a user terminal.

FIG. 3 is a view for illustrating an example of the work support screen displayed on the user terminal.

FIG. 4 is a diagram f for illustrating an example of functions implemented in the work support system.

FIG. 5 is a diagram for illustrating an example of an AI used in generation of storage data.

FIG. 6 is a table for showing an example of a work support database.

FIG. 7 is a flow chart for illustrating an example of processing executed in the work support system.

FIG. 8 is a diagram for illustrating an example of functions implemented in a work support system according to modification examples.

FIG. 9 is a diagram for illustrating an example of processing for correction of the storage data.

### DESCRIPTION OF THE EMBODIMENTS

### 1. Hardware Configuration

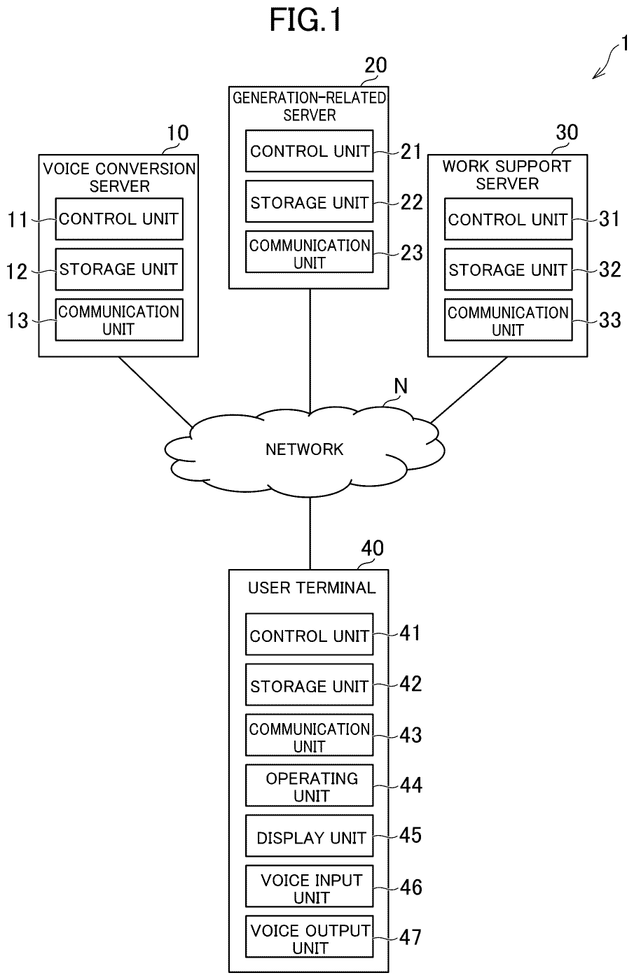

An example of a work support system, a work support method, and a program according to at least one embodiment of the present disclosure is described. FIG. 1 is a diagram for illustrating an example of a hardware configuration of the work support system. For example, a work support system 1 includes a voice conversion server 10, a generation-related server 20, a work support server 30, and a user terminal 40. Each of the voice conversion server 10, the generation-related server 20, the work support server 30, and the user terminal 40 is connected to a network N such as the Internet or a LAN. One voice conversion server 10, one generation-related server 20, one work support server 30, and one user terminal 40 are illustrated in FIG. 1, but at least one thereof may be provided as two or more components.

The voice conversion server 10 is a server computer that executes voice conversion processing described below. For example, the voice conversion server 10 includes a control unit 11, a storage unit 12, and a communication unit 13. The control unit 11 includes at least one processor. The storage unit 12 includes at least one of a volatile memory such as a RAM, or a non-volatile memory such as a flash memory. The communication unit 13 includes at least one of a communication interface for wired communication or a communication interface for wireless communication.

The generation-related server 20 is a server computer that executes generation-related processing described below. For example, the generation-related server 20 includes a control unit 21, a storage unit 22, and a communication unit 23. Hardware configurations of the control unit 21, the storage unit 22, and the communication unit 23 may be the same as those of the control unit 11, the storage unit 12, and the communication unit 13, respectively.

The work support server 30 is a server computer that executes work support processing described below. For example, the work support server 30 includes a control unit 31, a storage unit 32, and a communication unit 33. Hardware configurations of the control unit 31, the storage unit 32, and the communication unit 33 may be the same as those of the control unit 11, the storage unit 12, and the communication unit 13, respectively.

The user terminal 40 is a computer of a user. For example, the user terminal 40 is a personal computer, a tablet terminal, a smartphone, or a wearable terminal. The user terminal 40 includes a control unit 41, a storage unit 42, a communication unit 43, an operating unit 44, a display unit 45, a voice input unit 46, and a voice output unit 47. Hardware configurations of the control unit 41, the storage unit 42, and the communication unit 43 may be the same as those of the control unit 11, the storage unit 12, and the communication unit 13, respectively. The operating unit 44 includes an input device such as a mouse or a touch panel. The display unit 45 includes a liquid crystal display or an organic EL display. The voice input unit 46 includes at least one microphone. The voice output unit 47 includes at least one speaker.

Programs stored in the storage units 12, 22, 32, and 42 may be supplied via the network N. A hardware configuration of each of the voice conversion server 10, the generation-related server 20, the work support server 30, and the user terminal 40 is not limited to the example of FIG. 1. For example, at least one of the voice conversion server 10, the generation-related server 20, the work support server 30, or the user terminal 40 may include at least one of a reading unit (for example, a memory card slot) that reads a computer-readable information storage medium or an input/output unit (for example, a USB terminal) for directly connecting to an external device. A program stored in the information storage medium may be supplied to at least one of the voice conversion server 10, the generation-related server 20, the work support server 30, or the user terminal 40 through at least one of the reading unit or the input/output unit.

Moreover, the work support system 1 is only required to include at least one computer. The computers included in the work support system 1 are not limited to the example of FIG. 1. For example, the work support system 1 may include only the generation-related server 20 and the work support server 30. In this case, the voice conversion server 10 and the user terminal 40 are present outside the work support system 1. The work support system 1 may include only the generation-related server 20. In this case, the voice conversion server 10, the work support server 30, and the user terminal 40 are present outside the work support system 1. The work support system 1 may include the generation-related server 20 and another server computer.

### 2. Overview of Work Support System

In the at least one embodiment, the work support system 1 can support work of users through use of a database designed with no-code or low-code. The no-code means that the user does not input any code. In other words, the no-code means that the user is not required to input any code to use the work support system 1. The low-code means that the user inputs only minimum required code. In other words, the user is only required to input the minimum required code to use the work support system 1.

The code refers to a command for a computer. In other words, the code refers to information for a computer to understand an instruction of the user. The code may be any code used in the field of computer software. For example, the code may be a programming language code, a cascading style sheets (CSS) code, a database language code, a markup language code, or another code. Programming languages also include languages called scripting languages. The code in the at least one embodiment may be any one of various codes that a person skilled in the field of computer software calls code.

The database designed with no-code refers to a database that can be used even when the user does not input any code. In other words, the database designed with no-code can also be said to be a database provided in advance or a database designed with code provided in advance. The database designed with low-code refers to a database that can be used when the user inputs the minimum required code. In other words, the database designed with low-code can also be said to be a database designed with the code input by the user and the code provided in advance.

The work support system 1 being able to support work of users through use of a database means that the work support system 1 provides a database to the user. For example, the work support system 1 supports work of users by referring to, updating, deleting, or performing another operation on the database based on the input of the user. A type of the database may be a publicly-known type. For example, the database may be a relational database, a non-relational database, an object database, a database in a markup language such as XML, or another type of database. Code used in designing each of those databases may be code in a publicly-known database language.

The meaning of each of the terms “no-code” and “low-code” may be a commonly known meaning. A person skilled in the field of computer software can understand the meaning of each of the no-code and the low-code based on the common general technical knowledge at the time of filing. Each of the no-code and the low-code may have a publicly-known meaning that a person skilled in the art can understand based on the common general technical knowledge at the time of filing. For example, an amount of the minimum required code for the low-code may be an amount that a person skilled in the art can understand based on the common general technical knowledge at the time of filing. For example, the amount of the minimum required code for the low-code may be about 1 line to 100 lines, or may be 101 lines or more.

For example, the work support system 1 has various work support functions for supporting work of users. The work support function is a function implemented by a program developed for work support. Types of work support functions may be publicly-known types. For example, the work support function may be a database function for the user to store data in a database, a communication function for the user to communicate with another user, a schedule function for the user to manage a schedule, an email management function for the user to manage emails, or another function.

In the at least one embodiment, a case in which the work support system 1 provides users with groupware of a cloud type is taken as an example. The work support system 1 may provide users with groupware of an on-premises type. The work support system 1 may provide users with a service that is not classified as groupware but supports work. For example, an organization such as a corporation to which users belong contracts with the work support system 1. As a member of the organization, each user uses the work support function of the work support system 1. When the user logs in to the work support system 1 from a browser of the user terminal 40, the user terminal 40 displays, on the display unit 45, a work support screen for the user to use the work support function. The work support screen may be displayed on a program dedicated to the work support system 1 instead of being displayed on a browser.

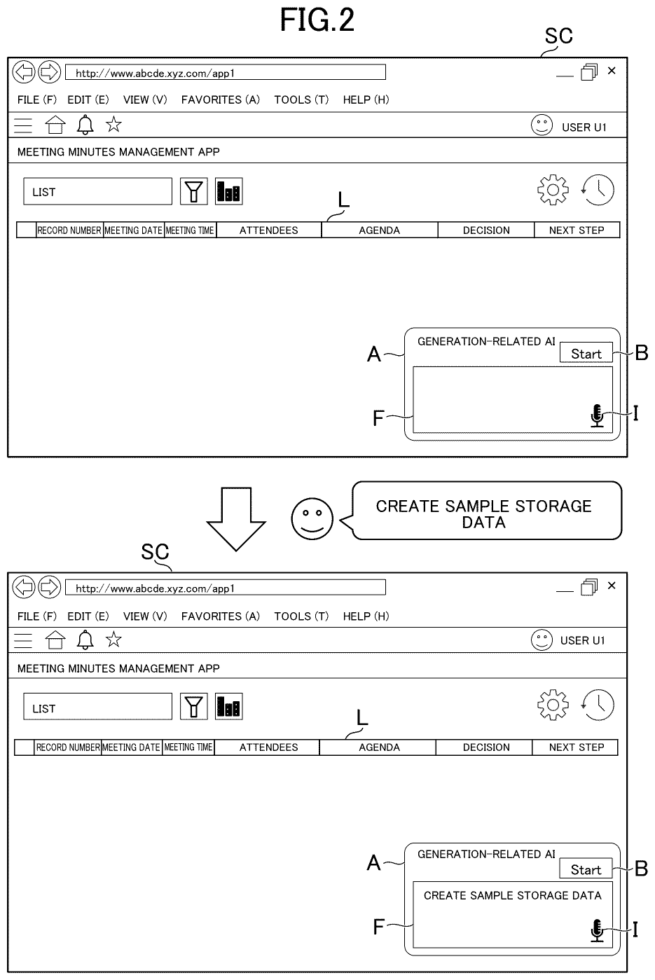

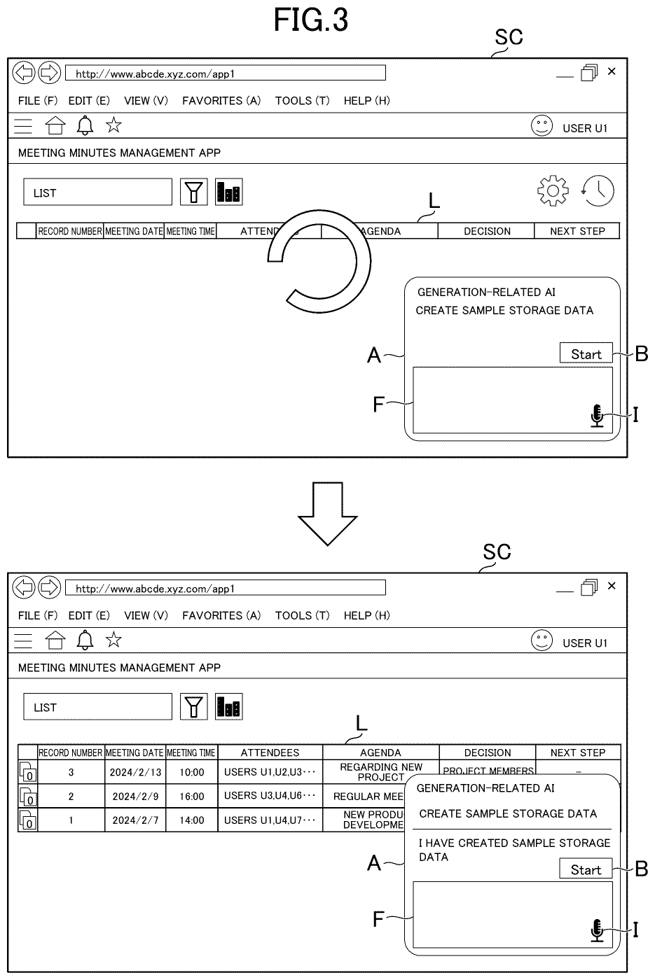

FIG. 2 and FIG. 3 are diagrams for illustrating examples of the work support screen displayed on the user terminal 40. In the at least one embodiment, a case in which the user uses a database function is taken as an example. For example, the user uses an app that is a type of database. The user can store, in the app, any data relating to his or her own work. For example, the user can store, in the app, not only data stored in fields of the app but also other data. For example, the user can store, in the app, comments on other users, files such as documents or images, or other data. The app can be said to be a complex work support function that combines not only the database function but also a communication function and a file management function.

For example, when the user selects the app, the user terminal 40 displays, on the display unit 45, a work support screen SC indicating a list L of records that are units of data that forms the app as in the upper half of FIG. 2. In the example in the upper half of FIG. 2, the list L of a meeting minutes management app for the user to manage meeting minutes is displayed on the work support screen SC. No record has been stored in this app yet. Thus, content of any record is not displayed in the list L. Only field names are displayed in the list L. After the user creates a record in the app, the record is displayed in the list L. When the user selects a record in the list L, the user terminal 40 displays details of the record on the work support screen SC. For example, the user can update the record from the work support screen SC.

In the at least one embodiment, the user can create an app with no-code or low-code. For example, the user can create an app by performing only a simple setting task such as a field setting even without inputting any code. The user can use a default app provided in advance even without performing a setting task. The user can extend the work support function of the app by inputting the minimum required code. That is, the user can create a low-code app by extending the work support function of the app created with no-code. The extension of the work support function can also be said to be customization of the work support function.

For example, the user may extend the function of the app by inputting a script to be executed by the browser of the user terminal 40. The script is a code written in a scripting language. The user may extend the function of the app by inputting a cascading style sheets (CSS) code. The work support system 1 may be compatible with another code other than the script and the CSS. For example, the user inputs code for changing the operation or appearance on a screen. The user may cause an artificial intelligence (AI) described later to generate code.

For example, code for the extension of the function of the app is uploaded to the work support server 30 and deployed to the app. In the at least one embodiment, the work support server 30 executes a series of processing steps such as deployment of the code based on a code execution API that is an API for deploying the code to the app and executing the code. The API is an interface for linking a plurality of programs (applications) to each other. The API can also be an interface for a certain program (a certain application) to call up another program (another application). A mechanism of the API may be a publicly-known mechanism.

For example, after the user creates code for the extension of the function of the app, the user verifies whether or not the code operates as desired. For verification work for the code, some data may be required in the app. However, under a state in which no data is stored in the app as in the upper half of FIG. 2, the user cannot perform the verification work for the code. In order to perform the verification work for the code, the user is required to store data serving as a sample in the app, thereby requiring a user to take time and labor. The data to be stored in the app is hereinafter referred to as “storage data.”

In view of this, the work support system 1 according to the at least one embodiment has a storage data generation function of generating storage data through use of an AI. The storage data generation function is a type of work support function. The storage data generation function may be a default function (function that can be used by all users from the beginning) of the work support system 1, but in the at least one embodiment, is assumed to be a plug-in that can be freely added by the user. The user who wishes to use the storage data generation function adds the storage data generation function by the plug-in. The plug-in is a collection of programs and data for the storage data generation function. When the user adds the plug-in, the user can use the programs and data for the storage data generation function.

The AI is a program having artificial intelligence that supports work of users. There are various views in terms of definitions of the AI, but the AI in the at least one embodiment may be an AI defined by any one of various publicly-known definitions. The AI may be an AI called a generative AI or a conversational AI. Examples of the AI may include a large language model, a machine learning model not classified as a large language model, a program called a bot, or other programs. There are also various views in terms of definitions of machine learning, but the machine learning in the at least one embodiment may be machine learning defined by any one of various publicly-known definitions. The machine learning may be any one of supervised learning, semi-supervised learning, or unsupervised learning.

In the at least one embodiment, a case in which the large language model corresponds to the AI is taken as an example. For example, the user uses text (characters) or voice to give an instruction to the AI. In the example in the upper half of FIG. 2, the user selects an icon I for starting voice input, and speaks. When the voice input unit 46 detects the voice of the user, the user terminal 40 executes, between the user terminal 40 and the voice conversion server 10, processing for converting the voice of the user into text. When the voice of the user is converted into text, as in the lower half of FIG. 2, the user terminal 40 displays the text in an input form F. When the text is incorrect, the user can correct the text by operating the operating unit 44. The user can also manually input text in the input form F without using the voice input.

In the example in the lower half of FIG. 2, the user gives an instruction such as “Create sample storage data.” For example, in order for the user to perform verification work for the app, storage data corresponding to the app currently displayed on the work support screen SC is required. For example, when the user selects a button B, the generation-related server 20 uses the AI to generate storage data corresponding to the currently displayed app. As in the upper half of FIG. 3, the work support screen SC is in a state waiting for the generation of storage data. The instruction input by the user is displayed in a display region A of the work support screen SC.

For example, the generation-related server 20 transmits, to the work support server 30, an API request indicating that the storage data generated by the AI is to be stored in the app. The AI may generate an API request. The work support server 30 receives the API request from the generation-related server 20. The work support server 30 stores the storage data in the app based on the API request. As in the lower half of FIG. 3, the user terminal 40 displays the storage data generated by the AI in the list L. In the example in the lower half of FIG. 3, the AI generates three records as the storage data. The user performs the verification work for the code based on the storage data generated by the AI. In the at least one embodiment, a case in which each individual record corresponds to the storage data is taken as an example, but a plurality of records may correspond to one piece of storage data, or each individual item included in one record may correspond to the storage data.

As described above, when the user inputs an instruction to the AI, the generation-related server 20 generates storage data that meets the instruction. The generation-related server 20 transmits, to the work support server 30, the API request indicating that the storage data generated by the AI is to be stored in the app. The work support server 30 executes the processing requested by the API request, and stores the storage data in the app. This enables the user to perform the verification work for the code even without providing the storage data by himself or herself, and hence the work support system 1 can increase convenience of the user. Details of the work support system 1 are described below.

### 3. Functions Implemented in Work Support System

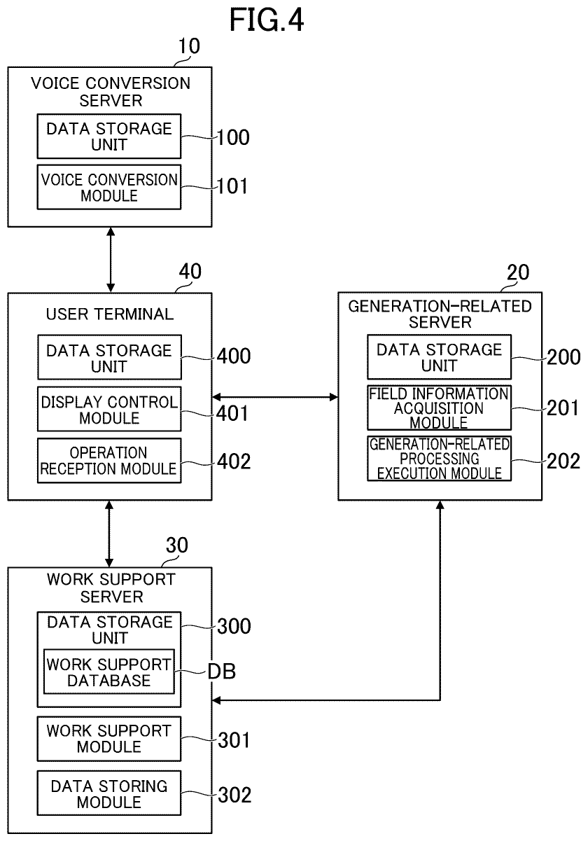

FIG. 4 is a diagram for illustrating an example of functions implemented in the work support system 1.

### 3-1. Functions Implemented in Voice Conversion Server

For example, the voice conversion server 10 includes a data storage unit 100 and a voice conversion module 101. The data storage unit 100 is implemented by the storage unit 12. The voice conversion module 101 is implemented by the control unit 11. When voice input is not performed, the work support system 1 is not required to include the voice conversion server 10.

### Data Storage Unit

The data storage unit 100 stores data required for the voice conversion processing. For example, the data storage unit 100 stores a voice conversion program indicating the voice conversion processing. The voice conversion processing is at least one of processing for converting voice into text or processing for converting text into voice. In the at least one embodiment, a case in which the voice conversion processing includes both of those kinds of processing is taken as an example, but the voice conversion processing may be only any one of those kinds of processing. The voice conversion program for converting voice into text and the voice conversion program for converting text into voice may be separately provided. The voice conversion program may be a publicly-known program. For example, the voice conversion program may be a program of a pattern matching method using a voice waveform pattern, a machine learning method, or another method.

### Voice Conversion Module

The voice conversion module 101 executes the voice conversion processing based on the voice conversion program. For example, the voice conversion server 10 acquires input voice data indicating voice input by the user from the user terminal 40. A data format of the input voice data may be a publicly-known format. The voice conversion module 101 converts the voice input by the user into text based on the voice data and the voice conversion program. The voice conversion module 101 transmits input text data indicating text of the voice input by the user to the user terminal 40. The voice conversion module 101 may transmit the input text data to the generation-related server 20, the work support server 30, or another computer.

For example, the voice conversion module 101 acquires answer text data indicating text of an answer from the AI from the generation-related server 20, the work support server 30, or another computer. The voice conversion module 101 converts the text of the answer from the AI into voice based on the answer text data and the voice conversion program. The voice conversion module 101 transmits answer voice data indicating voice of the text of the answer from the AI to the user terminal 40. The user terminal 40 acquires the answer voice data from the voice conversion server 10. The user terminal 40 outputs the answer from the AI by voice from the voice output unit 47 based on the answer voice data. The user terminal 40 may acquire the answer text data from the voice conversion server 10, the generation-related server 20, the work support server 30, or another computer. The user terminal 40 may display the answer from the AI in the display region A of the work support screen SC based on the answer text data.

### 3-2. Functions Implemented in Generation-Related Server

For example, the generation-related server 20 includes a data storage unit 200, a field information acquisition module 201, and a generation-related processing execution module 202. The data storage unit 200 is implemented by the storage unit 22. Each of the field information acquisition module 201 and the generation-related processing execution module 202 is implemented by the control unit 21.

### Data Storage Unit

The data storage unit 200 stores data required for generation-related processing. For example, the data storage unit 200 may store information (for example, a URL or an IP address) that can identify an API endpoint of the API in the work support server 30. In the at least one embodiment, a case in which the generation-related server 20 uses the AI of an external service that cooperates with the work support system 1 is taken as an example, and hence it is assumed that the data storage unit 200 does not store the AI itself, but the data storage unit 200 may store the AI itself. That is, in the at least one embodiment, a case in which actual data of the AI is stored in a system for another service is taken as an example, but the data storage unit 200 may store the actual data of the AI.

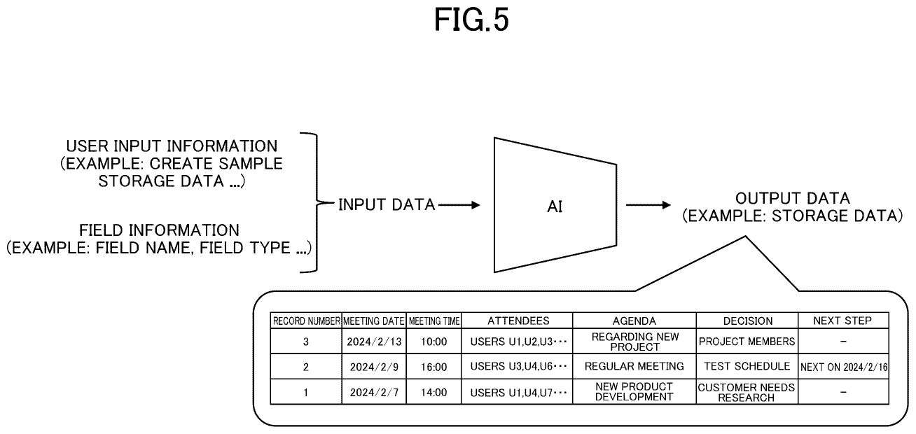

FIG. 5 is a diagram for illustrating an example of the AI used in generation of storage data. For example, the AI includes: a program indicating a series of processing steps such as calculation of an embedded representation; and parameters to be referred to by the program. The embedded representation is information for the AI to understand the meaning of data. For example, the embedded representation is represented by a multidimensional vector. The embedded representation may also be called a feature amount indicating a feature of data. The embedded representation may be represented in another format other than the multidimensional vector. The AI may include other data (for example, data equivalent to a dictionary of terms) other than the parameters. The other data is referred to by the program. The other data may be data separate from the AI. The AI calculates the embedded representation of input data input to itself based on the parameters, and performs output corresponding to the embedded representation. For example, the parameters are weights and biases.

The program and parameters of the AI may be a publicly-known program and publicly-known parameters, respectively. For example, the program and parameters of the AI may be a program and parameters employed in a large language model, such as a generative pre-trained transformer (GPT) or bidirectional encoder representations from transformers (BERT), a program and parameters employed in a machine learning model, such as a neural network or generative adversarial networks (GAN), a program and parameters employed in a generative AI or a conversational AI that is not classified into those, or another program and other parameters. The program and parameters of the AI may be selected from various programs and parameters that can be understood by a person skilled in the field of computer software based on the common general technical knowledge at the time of filing.

In the at least one embodiment, a large language model (for example, GPT) is described as an example of the AI, and hence the program of the AI indicates processing for analyzing input data input to the AI. The parameters of the AI are parameters such as weights and biases that are referred to by the AI to analyze the meaning in a natural language. The AI performs language analysis on the input data input to itself based on the parameters adjusted by training, and performs output corresponding to a result of the language analysis. For example, the AI divides the text in a natural language indicated by the input data into a plurality of tokens. The AI calculates the embedded representations indicating the meanings of the individual tokens based on the parameters. The AI understands the meaning in a natural language based on a sequential order of the embedded representations of the respective tokens. The AI may make a prediction based on the sequential order of the embedded representations of the respective tokens as required. The AI outputs output data corresponding to the sequential order of the embedded representations.

In the at least one embodiment, a case in which various codes related to data generation (such as database language codes) have been learned by the AI is taken as an example. The AI may learn only a code that can be handled by the work support system 1, but in the at least one embodiment, it is assumed that other codes have been learned as well. The AI may be capable of handling codes in various languages. For example, the output data from the AI may differ depending on the input data. When the input data is some question, the output data indicates an answer to the question. When the input data is an instruction to generate storage data, the output data includes the storage data. In this case, the output data may include not only the storage data but also an explanation of the storage data. The output data may include any type of information.

As in FIG. 5, in the at least one embodiment, a case in which the input data to the AI includes user input information and field information is taken as an example. Details of those pieces of information included in the input data are described later. The input data is only required to include at least the field information. The input data is not limited to the example in the at least one embodiment. For example, the user input information is not required to be included in the input data. Even when the user input information is not included in the input data, the AI can generate storage data even without the user input information as long as the AI has learned in advance that the AI is required to generate storage data. For example, when the AI is specialized in generating storage data, the AI may generate storage data based on the input data including only the field information. When the AI is a general-purpose AI that is not specialized in generating storage data, a default prompt described later may include information indicating that the generation of storage data is a task of the AI. The AI can recognize, based on such information, that the AI is required to generate storage data.

In the at least one embodiment, a case in which the output data includes the storage data is taken as an example. For example, the output data may include information (for example, an answer from the AI) other than the storage data. The output data from the AI may not include the storage data but may include intermediate code to be used to generate storage data. The output data is not required to include the storage data. For example, when the output data does not include the storage data, the generation-related processing execution module 202 described later may generate an API request for requesting generation of storage data based on the output data. For example, when the output data is code such as a script generated by the AI and includes only code for generating storage data, the generation-related processing execution module 202 may generate an API request for the execution of the code based on the output data that is the code such as a script generated by the AI. The API request is transmitted to another computer such as the work support server 30, and the other computer generates storage data based on the API request.

### Field Information Acquisition Module

The field information acquisition module 201 acquires field information relating to each field of the app. The app is an example of the database designed with no-code or low-code. Thus, the app as used herein can be read as the database designed with no-code or low-code. The database designed with no-code or low-code may be another database other than the app. Examples of the other database are as described above.

The field is each individual item that forms a record. The record is each individual unit of data in the app. The field may also be called by another name such as a cell. The field information is only required to be information relating to each field. In the at least one embodiment, a case in which the field information is a field setting is taken as an example, but the field information may be a specific value of the field. The field setting may be able to be designated by the user, or may not be able to be designated by the user.

For example, the field information may indicate, as the field setting, a field name that is a name of the field, a field code that is a code of the field, a field type that is a type of the field, a calculation formula associated with the field, a sequential order of the field, a position of an input form for the user to input a value of the field, a design of the field on the work support screen SC, an access right to the field, or another setting. The field information may indicate a plurality of settings among those.

For example, when the user selects the button B with the text having been input in the input form F of the work support screen SC, the field information acquisition module 201 acquires an app ID of the app selected by the user from the user terminal 40. The app ID is assumed to be included in display data (for example, HTML data) on the work support screen SC. The app ID may be included as part of a URL (for example, an argument included in a link for the button B). It suffices that the field information acquisition module 201 acquires the app ID of the app for which storage data is to be generated in some way. The field information acquisition module 201 may acquire the app ID of the app selected by the user from the voice conversion server 10, the work support server 30, or another computer.

For example, the field information acquisition module 201 requests the work support server 30 for the field information based on the app ID of the app selected by the user. It is assumed that the request includes the app ID. When the work support server 30 receives the request, the work support server 30 refers to a work support database DB to acquire field information associated with the app ID. The work support server 30 transmits the field information to the generation-related server 20. The field information acquisition module 201 acquires the field information from the work support server 30.

In the examples of FIG. 2 and FIG. 3, the meeting minutes management app selected by the user has seven fields including “Record Number,” “Meeting Date,” “Meeting Time,” “Attendees,” “Agenda,” “Decision,” For example, the field information acquisition module 201 acquires the field information including field codes, field names, field types, and a sequential order of those seven fields or a combination of those of the seven fields. When other setting items are present as the field setting items, the field information acquisition module 201 may acquire the field information including the other setting items.

When the user uses another database other than the app, it suffices that the field information acquisition module 201 acquires the field information from the other database. When the data storage unit 200 stores the field information, the field information acquisition module 201 may acquire the field information from the data storage unit 200. The field information acquisition module 201 may acquire the field information from another computer (for example, the user terminal 40) other than the generation-related server 20 and the work support server 30 or an external information storage medium.

### Generation-Related Processing Execution Module

The generation-related processing execution module 202 executes the generation-related processing. The generation-related processing is processing relating to the generation of storage data to be stored in the app. In the at least one embodiment, a case in which the processing for generating storage data itself corresponds to the generation-related processing is taken as an example, but the generation-related processing may be pre-processing that is executed in advance for generating storage data. For example, the pre-processing may be generation of a file (for example, a comma-separated values (CSV) file) to be imported as the storage data, generation of a program for generating storage data, generation of an API request for requesting the generation of storage data, or other processing.

In the at least one embodiment, the generation-related processing execution module 202 executes the generation-related processing relating to the generation of storage data to be stored in the app based on the field information and the AI. For example, the generation-related processing execution module 202 inputs the input data including the user input information to the AI. In the at least one embodiment, the AI is stored in an external system, and hence the generation-related processing execution module 202 transmits the input data to the external system. When the AI is stored in the data storage unit 200, the generation-related processing execution module 202 is only required to input the input data to the AI stored in the data storage unit 200.

For example, the AI calculates the embedded representation of the input data based on parameters adjusted by previously performed training. In the at least one embodiment, a case in which a large language model exemplified by GPT corresponds to the AI is taken as an example, and hence the AI divides the input data into tokens and calculates the embedded representations of the individual tokens based on the parameters. The AI predicts a continuation based on the sequential order of the embedded representations of the tokens as required. The AI outputs the storage data as the output data based on the sequential order. The AI may output the output data including not only the storage data but also the text of the answer to the user. The generation-related processing execution module 202 acquires the storage data included in the output data output by the AI. In the at least one embodiment, the above-mentioned series of processing steps corresponds to the generation-related processing.

In the at least one embodiment, the generation-related processing execution module 202 executes the generation-related processing further based on the user input information relating to the input of the user. The generation-related processing execution module 202 acquires the user input information. In the at least one embodiment, a case in which the user inputs voice from the voice input unit 46 is taken as an example, but the user may also perform the input from the operating unit 44. For example, the user may input an instruction to the AI from the operating unit 44. The user may perform the input by selecting a part (for example, an image such as a button or a check box) serving as a user interface.

The user input information is an instruction to the AI. The user input information can also be said to be an intention of the user. The user input information may also be called a prompt for the AI. Among the pieces of information included in the input data, other pieces of information other than the user input information can also be said to be supplementary information to be input to the AI together with the prompt. There are various definitions of the term “prompt,” but when the information to be input to the AI corresponds to a prompt, other pieces of information other than the user input information also correspond to prompts. The definition of the term “prompt” may be any one of various publicly-known definitions. For example, the user input information indicates content in a natural language input by the user. The user can input any content. The user input information is written in a natural language, but may be information in which the meaning in the natural language is vectorized.

In the at least one embodiment, a case in which the text input in the input form F when the user selects the button B corresponds to the user input information is taken as an example. Thus, the user input information is text indicating that the user wishes storage data to be generated. When the user selects the button B, the user terminal 40 transmits the user input information, which is the text input in the input form F, to the generation-related server 20. The generation-related processing execution module 202 acquires the user input information from the user terminal 40. The generation-related processing execution module 202 may acquire only one piece of user input information, or may acquire a plurality of pieces of user input information.

The user input information may not be text in a natural language but may be the voice itself that has been used in the input by the user. In this case, the generation-related processing execution module 202 may acquire the user input information, which is the voice, from the user terminal 40 and then request the voice conversion server 10 to convert the user input information into text. The generation-related processing execution module 202 acquires the user input information converted into text from the voice conversion server 10. In the at least one embodiment, the AI is a large language model, and hence the information converted into text is input to the AI. The generation-related processing execution module 202 may acquire the user input information indirectly through the voice conversion server 10, the work support server 30, or another computer, instead of acquiring the user input information directly from the user terminal 40.

For example, the generation-related processing execution module 202 inputs the input data including the user input information to the AI. The AI calculates the embedded representation based on not only the information but also the user input information. The embedded representation reflects not only the field information but also the user input information. The AI outputs the output data including storage data corresponding to the calculated embedded representation. The generation-related processing execution module 202 acquires the storage data included in the output data output by the AI. For example, the AI identifies what kind of storage data is to be generated based on the embedded representation corresponding to the user input information, and generates storage data. In the examples of FIG. 2 and FIG. 3, storage data for verifying the extension of the function of the app, which is an example of the work support function, is generated.

In the at least one embodiment, the app is managed by the work support server 30, and hence the generation-related processing execution module 202 transmits the storage data to the work support server 30. That is, the generation-related processing execution module 202 requests the work support server 30 to store the storage data in the app. When processing for storing the storage data is executed by the API of the work support server 30, the generation-related processing execution module 202 transmits an API request including the storage data to the API endpoint of the API. A data storing module 302 described later stores the storage data in the app based on the API request. When actual data of the app is stored in the generation-related server 20, it suffices that the generation-related server 20 includes the data storing module 302 and the data storing module 302 of the generation-related server 20 stores the storage data in the app stored in the generation-related server 20.

The generation-related processing is not limited to the processing for generating storage data itself. The generation-related processing may be any processing relating to the generation of storage data in some way. For example, the generation-related processing may be pre-processing for generating storage data. The generation-related processing execution module 202 may execute processing for generating data such as a CSV file as the generation-related processing. In this case, the data storing module 302 described later may store the storage data in the app by importing data such as a CSV file into the app. The data is only required to have a format that enables the data to be imported into the app, and is not limited to CSV.

As an example of the generation-related processing, processing for generating an API request for requesting at least one of the generation or the storage of storage data may be executed as the generation-related processing. The generation-related processing execution module 202 transmits the API request generated by the generation-related processing to the work support server 30. When the work support server 30 receives the API request, the work support server 30 may execute the API request to perform at least one of the generation or the storage of storage data. A program required for generating storage data may be attached to the API request, or may be stored in advance in the work support server 30. The work support server 30 may execute the program to generate storage data.

As an example of the generation-related processing, processing for generating code (for example, code in a programming language such as Python or code in a database language) for generating storage data may be executed as the generation-related processing. The generation-related processing execution module 202 may execute the code to generate storage data. The code may be executed by the work support server 30. The data storing module 302 may store the storage data generated by the execution of the code in the app.

### 3-3. Functions Implemented in Work Support Server

For example, the work support server 30 includes a data storage unit 300, a work support module 301, and the data storing module 302. The data storage unit 300 is implemented by the storage unit 32. Each of the work support module 301 and the data storing module 302 is implemented by the control unit 31.

### Data Storage Unit

The data storage unit 300 stores data required for the work support processing. For example, the data storage unit 300 stores the work support database DB in which various kinds of data on the work support system 1 are stored. In the at least one embodiment, a scene in which the user extends the function of the app is taken as an example, and hence a case in which various kinds of data on the app are stored in the work support database DB is taken as an example.

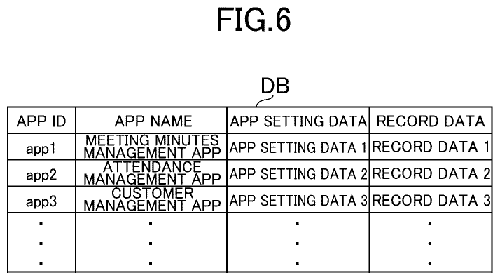

FIG. 6 is a table for showing an example of the work support database DB. For example, the work support database DB stores an app ID, an app name, app setting data, and record data. The data stored in the work support database DB is not limited to the example of FIG. 6. For example, the work support database DB may store other data (for example, data on conversation threading in which users communicate with each other, data on schedules, or data on emails) other than the app.

The app ID is an ID that can identify the app. The app name is a name of the app. The app setting data indicates the setting of the app designated by the user with no-code or low-code. For example, the app setting data may be the above-mentioned field setting, a graph setting, a display setting of the list L, an access right setting, or another setting. In the at least one embodiment, a case in which the field information is included in the app setting data is taken as an example, but the field information may be data separate from the app setting data. The code generated by the AI may be saved as part of the app setting data. The record data is data stored in a record. When the user creates a new app, data such as the app ID of the new app is stored in the work support database DB. When the user updates the app, the data on the app in the work support database DB is updated.

For example, the data storage unit 300 stores a program for the work support function and actual data of each of the plurality of APIs. The actual data of each API includes: a program for performing various kinds of processing such as acquisition or transmission of data; and data including settings to be referred to by the program. The program for the work support function can also be called up through the processing of the program included in the actual data of the API. The actual data of the API may be similar to data employed in a publicly-known API. The data storage unit 300 may store data (for example, information that can identify the API endpoint of each of the plurality of APIs) required for the work support server 30 to receive the API request.

The data stored in the data storage unit 300 is not limited to the above-mentioned example. It suffices that the data storage unit 300 stores data required for supporting work. For example, the data storage unit 300 may store data (for example, HTML data or image data) required for displaying the work support screen SC, or may store data (for example, a deployment program) required for deploying the code. The data storage unit 300 may store API specification information on each of the plurality of APIS.

### Work Support Module

The work support module 301 executes the work support processing for supporting work of users. The work support processing is processing for providing the work support function to the user. For example, the work support processing is processing for displaying the work support screen SC on the user terminal 40.

### Data Storing Module

The data storing module 302 stores the storage data in the app. For example, when the API request generated by the generation-related server 20 is transmitted to the work support server 30, the data storing module 302 stores the storage data in the app based on the API request transmitted to the work support server 30. When the API request is not used, the work support server 30 acquires the storage data from the generation-related server 20 without using the API request. The data storing module 302 may store the storage data acquired without using the API request in the app. For example, when the work support server 30 includes the generation-related processing execution module 202, the data storing module 302 stores the storage data in the app without particularly using the API request.

For example, the work support server 30 acquires, together with the storage data, the app ID of the app in which the storage data is to be stored, from the generation-related server 20. The data storing module 302 stores the storage data in the app indicated by the app ID. The data storing module 302 stores the storage data in the app by adding the storage data as a new record of the app. The data storing module 302 may store the storage data in the app by overwriting an existing record with the storage data instead of adding a new record. In the at least one embodiment, the record data is stored in the work support database DB, and hence the data storing module 302 updates the work support database DB so that the storage data is stored in the app in which the storage data is to be stored. In the at least one embodiment, the storage data is sample data (test data or demo data) for the user to perform the verification work, and hence the storage data may be discarded (deleted) from the app after the verification work.

### 3-4. Functions Implemented in User Terminal

For example, the user terminal 40 includes a data storage unit 400, a display control module 401, and an operation reception module 402. The data storage unit 400 is implemented by the storage unit 42. Each of the display control module 401 and the operation reception module 402 is implemented by the control unit 41.

### Data Storage Unit

The data storage unit 400 stores data for the work support. For example, the data storage unit 400 stores a browser for displaying various screens of the work support system 1. For example, the data storage unit 400 stores an application dedicated to the work support system 1. The data storage unit 400 stores the display data on the work support screen SC.

### Display Control Module

The display control module 401 displays various screens in the work support system 1 on the display unit 45. For example, the display control module 401 displays the work support screen SC on the display unit 45 based on data received from the voice conversion server 10, the generation-related server 20, or the work support server 30.

### Operation Reception Module

The operation reception module 402 receives various operations in the work support system 1. For example, the operation reception module 402 receives operations on the work support screen SC. Data indicating the operation content received by the operation reception module 402 is transmitted to the voice conversion server 10, the generation-related server 20, or the work support server 30 as appropriate.

### 4. Processing Executed in Work Support System

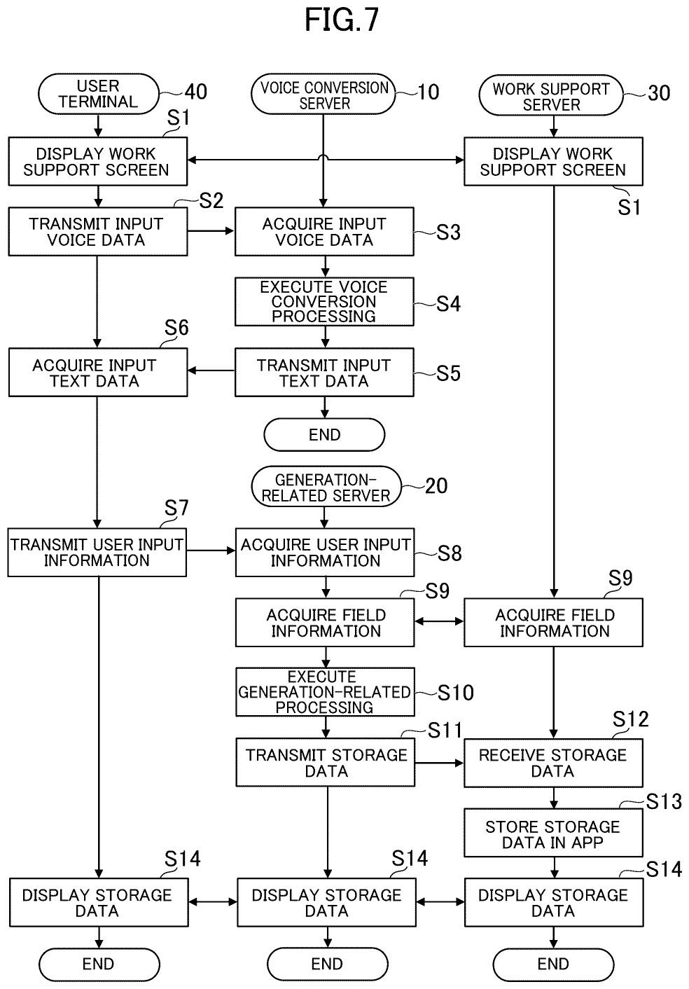

FIG. 7 is a flowchart for illustrating an example of processing executed in the work support system 1. The processing of FIG. 7 is executed by the control units 11, 21, 31, and 41 executing the programs stored in the storage units 12, 22, 32, and 42, respectively. Respective processing steps of FIG. 7 are examples of processing steps included in the work support method. In FIG. 7, an example of processing performed so as to generate storage data is illustrated. In FIG. 7, the user terminal 40 may communicate indirectly to/from each of the voice conversion server 10 and the generation-related server 20 through the work support server 30 instead of directly communicating to/from each thereof.

As illustrated in FIG. 7, the user terminal 40 executes, between the user terminal 40 and the work support server 30, the processing for displaying the work support screen SC of the app selected by the user (Step S1). In Step S1, the work support server 30 generates display data on the work support screen SC of the app selected by the user based on the work support database DB, and transmits the display data to the user terminal 40. When the user terminal 40 receives the display data on the work support screen SC, the user terminal 40 displays the work support screen SC on the display unit 45. After that, the user instructs the AI to generate storage data in accordance with a flow of FIG. 2 and FIG. 3.

When the user terminal 40 receives input of voice from the user through the voice input unit 46, the user terminal 40 transmits the input voice data indicating the voice input by the user to the voice conversion server 10 (Step S2). The voice conversion server 10 acquires the input voice data from the user terminal 40 (Step S3). The voice conversion server 10 executes the voice conversion processing based on the voice conversion program and the input voice data (Step S4). The voice conversion server 10 transmits the input text data indicating the text of the voice input by the user (Step S5). The user terminal 40 acquires the input text data from the voice conversion server 10 (Step S6).

When the user selects the button B, the user terminal 40 transmits the user input information to the generation-related server 20 (Step S7). In Step S7, the user terminal 40 requests the generation-related server 20 to generate storage data. In Step S7, the app ID of the app for which storage data is to be generated is transmitted as well. The generation-related server 20 acquires the user input information and the like from the user terminal 40 (Step S8). The generation-related server 20 executes, between the generation-related server 20 and the work support server 30, processing for acquiring the field information (Step S9).

The generation-related server 20 executes generation-related processing based on the AI and the input data including the user input information acquired in Step S8 and the field information acquired in Step S9 (Step S10). In Step S10, the generation-related server 20 transmits the input data to the external system managing the AI. The generation-related server 20 acquires the output data including the storage data generated by the AI from the external system. The generation-related server 20 transmits the storage data generated in Step S10 to the work support server 30 (Step S11). The storage data generated in Step S10 may be transmitted from the generation-related server 20 to the user terminal 40 and then transmitted to the work support server 30 by the user terminal 40.

The work support server 30 receives the storage data from the generation-related server 20 (Step S12). The work support server 30 stores the storage data in the app (Step S13). The work support server 30 cooperates with the generation-related server 20 and the user terminal 40 to execute the processing for displaying the storage data stored in the app on the work support screen SC (Step S14), and the processing ends. The work support server 30 transmits the display data on the work support screen SC to the user terminal 40 via the generation-related server 20. When the user terminal 40 receives the display data on the work support screen SC, the user terminal 40 displays the work support screen SC on the display unit 45. When voice output of the answer from the AI is required, the voice conversion server 10 acquires data indicating the answer from the AI from the generation-related server 20, and executes the processing for converting text into voice. The converted voice is output by the user terminal 40.

### 5. Summary of at Least One Embodiment

The work support system 1 according to the at least one embodiment executes the generation-related processing based on the field information and the AI. The work support system 1 stores the storage data in the database. Thus, even when the user does not provide the storage data by himself or herself, the work support system 1 generates storage data through use of the AI and stores the storage data in the database, and hence the work support system 1 can save the time and labor of the user and increase the convenience of the user. For example, the user of the no-code or low-code work support system 1 may not know the code for automatically generating storage data. The user can easily use the storage data by the generation-related processing of the work support system 1 even without acquiring knowledge of code. For example, the AI can recognize what kind of storage data is to be generated based on the field information. The work support system 1 can generate appropriate storage data corresponding to the field information on the app selected by the user.

### 6. Modification Examples

The present disclosure is not limited to the at least one embodiment described above. The present disclosure can be modified as required without departing from the purport of the present disclosure.

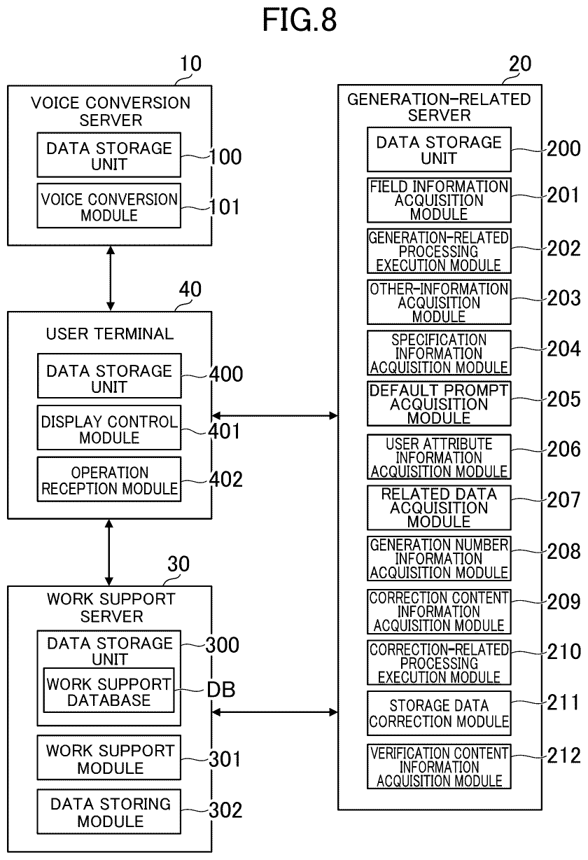

FIG. 8 is a diagram for illustrating an example of functions implemented in the work support system 1 according to modification examples. As illustrated in FIG. 8, in the modification examples described below, an other-information acquisition module 203, a specification information acquisition module 204, a default prompt acquisition module 205, a user attribute information acquisition module 206, a related data acquisition module 207, a generation number information acquisition module 208, a correction content information acquisition module 209, a correction-related processing execution module 210, a storage data correction module 211, and a verification content information acquisition module 212 are implemented. Each of the other-information acquisition module 203, the specification information acquisition module 204, the default prompt acquisition module 205, the user attribute information acquisition module 206, the related data acquisition module 207, the generation number information acquisition module 208, the correction content information acquisition module 209, the correction-related processing execution module 210, the storage data correction module 211, and the verification content information acquisition module 212 is implemented by the control unit 21.

### 6-1. Modification Example 1

For example, in the at least one embodiment, the case in which the generation-related processing execution module 202 executes the generation-related processing based on the user input information and the field information has been taken as an example. The generation-related processing execution module 202 may execute the generation-related processing further based on information other than the user input information and the field information. The work support system 1 according to Modification Example 1 includes the other-information acquisition module 203. The other-information acquisition module 203 acquires information relating to the app, the information being information other than the field information.

The information relating to the app is information associated with the app ID. The other information is all or part of the information relating to the app other than the field information. The other information may indicate another setting other than the field setting among settings relating to the app. For example, the other information may indicate a setting of the app itself. The other information may be an app name that is a name of the app, a note for an administrator of the app, a display format of the list L, an icon of the app, a design of the app, a setting of a workflow, a notification setting, a plug-in added to the app, a function extended by a script, CSS, or the like, an access right, or a hierarchical format of records. The other information may be information that is not a setting. For example, the other information may be a file uploaded to a location other than the field of the app or a comment input by the user. The other information may be a comment of a user registered in each individual record.

In Modification Example 1, it is assumed that the information relating to the app is included in the app setting data in the work support database DB. The other-information acquisition module 203 requests the work support server 30 for other information based on the app ID of the app selected by the user. The request is assumed to include the app ID. When the work support server 30 receives the request, the work support server 30 refers to the work support database DB to acquire the other information associated with the app ID. The work support server 30 transmits the other information to the generation-related server 20. The other-information acquisition module 203 acquires the other information from the work support server 30.

When the user uses another database other than the app, the other-information acquisition module 203 is only required to acquire information other than the field information from among pieces of information relating to the other database. When the data storage unit 200 stores the other information, the other-information acquisition module 203 may acquire the other information from the data storage unit 200. The other-information acquisition module 203 may acquire the other information from another computer (for example, the user terminal 40) other than the generation-related server 20 and the work support server 30 or an external information storage medium.

The generation-related processing execution module 202 in Modification Example 1 executes the generation-related processing further based on the other information. The phrase “further based on the other information” means that the subject is based on not only the AI and the field information but also the other information. For example, the generation-related processing execution module 202 inputs the input data including the other information to the AI. The AI calculates the embedded representation based on not only the field information but also the other information. The embedded representation reflects not only the field information but also the other information. The AI outputs the output data including the storage data corresponding to the calculated embedded representation. The generation-related processing execution module 202 acquires the storage data included in the output data output by the AI. For example, the AI identifies what kind of storage data is to be generated based on the embedded representation corresponding to the other information, and generates storage data.

The generation-related processing in Modification Example 1 is not limited to the processing for generating storage data further based on the other information. The generation-related processing in Modification Example 1 may be other processing as in the at least one embodiment. For example, the generation-related processing execution module 202 may execute the generation-related processing by generating data such as a CSV file further based on the other information and importing the data into the app. The generation-related processing execution module 202 may execute the generation-related processing by generating an API request for requesting at least one of the generation or the storage of storage data further based on the other information. The generation-related processing execution module 202 may execute the generation-related processing by generating code for generating storage data further based on the other information.

The work support system 1 according to Modification Example 1 executes the generation-related processing further based on the information relating to the app and being the information other than the field information. The work support system 1 can generate storage data specific to the information other than the field information. For example, when a purpose of the app is indicated in the app name, the work support system 1 can generate storage data that matches the purpose of the app, thereby increasing accuracy of the storage data. When the process of creation of the app is indicated in the note for the administrator, the work support system 1 can generate storage data that matches the process, thereby increasing the accuracy of the storage data.

### 6-2. Modification Example 2

For example, the storage data may require specifications specific to the work support system 1. Thus, the work support system 1 may execute the generation-related processing further based on the specifications. The work support system 1 according to Modification Example 2 includes the specification information acquisition module 204. The specification information acquisition module 204 acquires specification information relating to specifications in the work support system 1.

The specifications are specifications required for the storage data. For example, the specifications may be a data format (data type), a data size, a value range (for example, numerical range), and an extension of the storage data, specifications of the API to be used in processing such as the storage of the storage data, security specifications required for the storage data, or other specifications. The specifications in the work support system 1 may be specifications employed in a publicly-known service. For example, the specifications in the work support system 1 may be specifications for the extension of the work support function.

In the at least one embodiment, the specifications in the work support system 1 are written in a natural language so that the AI, which is a large language model, can recognize the specifications in the work support system 1. The specification information may have any data format. For example, the specification information may be a text file, a rich text file, a document file, or an HTML file, or may have another format. The specification information may be written in a language that can be understood by a computer instead of a natural language that can be understood by a human. The specification information may be the same as information that has been published to users on the website of the work support system 1, or may be information different from the published information. The specification information may be processed so as to be easily recognized by the AI. The specification information may include another element such as a table or a drawing in addition to the text.

In Modification Example 2, a case in which the data storage unit 200 stores the specification information is taken as an example. For example, the specification information acquisition module 204 acquires the specification information from the data storage unit 200. The specification information acquisition module 204 may acquire the specification information from another database other than that of the data storage unit 200, another computer other than the generation-related server 20, or an external information storage medium. The specification information acquisition module 204 may acquire only one piece of specification information, or may acquire a plurality of pieces of specification information. For example, the specification information acquisition module 204 may acquire all pieces of specification information stored in the data storage unit 200. In the at least one embodiment, the specification information acquisition module 204 acquires some pieces of specification information among all the pieces of specification information stored in the data storage unit 200. For example, the specification information acquisition module 204 may acquire the specification information corresponding to a screen that was displayed on the user terminal 40 when the user input information was input.

The generation-related processing execution module 202 in Modification Example 2 executes the generation-related processing further based on the specification information. The phrase “further based on the specification information” means that the subject is based on not only the AI and the field information but also the specification information. For example, the generation-related processing execution module 202 inputs the input data including the specification information to the AI. The AI calculates the embedded representation based on not only the field information but also the specification information. The embedded representation reflects not only the field information but also the specification information. The AI outputs the output data including the storage data corresponding to the calculated embedded representation. The generation-related processing execution module 202 acquires the storage data included in the output data output by the AI. For example, the AI identifies what kind of storage data is to be generated based on the embedded representation corresponding to the specification information, and generates storage data.

The generation-related processing in Modification Example 2 is not limited to the processing for generating storage data further based on the specification information. The generation-related processing in Modification Example 2 may be other processing as in the at least one embodiment. For example, the generation-related processing execution module 202 may execute the generation-related processing by generating data such as a CSV file further based on the specification information and importing the data into the app. The generation-related processing execution module 202 may execute the generation-related processing by generating an API request for requesting at least one of the generation or the storage of storage data further based on the specification information. The generation-related processing execution module 202 may execute the generation-related processing by generating code for generating storage data further based on the specification information.

The work support system 1 according to Modification Example 2 executes the generation-related processing further based on the specification information. This enables the work support system 1 to generate storage data specific to the specification information. For example, when the specifications define that the storage data has a specific format, the work support system 1 can generate storage data in the specific format, thereby increasing the accuracy of the storage data. When the specifications define that the storage data fits within a specific size, the work support system 1 can generate storage data that fits within the specific size, thereby increasing the accuracy of the storage data.

### 6-3. Modification Example 3

For example, the user may not input information required for the generation of storage data. That is, the user input information may not include sufficient information. For that reason, a default prompt provided on the work support system 1 side may be input to the AI so as to supplement missing information. The work support system 1 according to Modification Example 3 includes the default prompt acquisition module 205. The default prompt acquisition module 205 acquires a default prompt relating to the generation of an app, the default prompt being provided in advance.

In Modification Example 3, a case in which the default prompt is provided by the business operator operating the work support system 1 is taken as an example, but the default prompt may be provided by any person. For example, the user may provide the default prompt, or another user in an organization to which the user belongs may provide the default prompt. The default prompt may be shared between users. The default prompt may be provided by another business operator cooperating with the business operator operating the work support system 1.

In Modification Example 3, a case in which the data storage unit 200 stores the default prompt is taken as an example. For example, the default prompt acquisition module 205 refers to the data storage unit 200 to acquire the default prompt. The default prompt acquisition module 205 may acquire the default prompt from another computer other than the generation-related server 20 or an external information storage medium. The default prompt acquisition module 205 may acquire only one default prompt, or may acquire a plurality of default prompts. The default prompt acquisition module 205 may acquire a default prompt corresponding to the app selected by the user among a plurality of default prompts.

For example, the AI may be capable of generating data in various data formats. Meanwhile, the work support system 1 may only support a specific data format (for example, CSV). In this case, the user may not designate the specific data format. For that reason, text indicating that the AI is to generate storage data in a specific data format may be provided as the default prompt. Such a default prompt enables the AI to identify in which data format the storage data is to be generated.

For example, the default prompt may be text indicating a role to be played by the AI, such as “You are an AI that supports the user in generating storage data.” Such a default prompt enables the AI to identify the role to be played by itself. For another example, the default prompt may be text indicating that the AI is to give some kind of answer to the user together with the storage data, such as “Please explain the storage data you have generated.” Such a default prompt enables the AI to identify that the AI is to generate an answer (for example, an explanation of the storage data) to the user together with the storage data.

For example, the default prompt may be text indicating what kind of information each of the field information and the user input information is. The default prompt may be text such as “This information is the field information on the app. Please generate storage data corresponding to the field information on the app based on this information.” Such a default prompt enables the AI to identify that the field information is information on the field of the app. In the same manner, for the user input information, the default prompt may indicate that the user input information is information indicating the input of the user. Such a default prompt enables the AI to identify how to use the user input information.

The generation-related processing execution module 202 in Modification Example 3 executes the generation-related processing further based on the default prompt. The phrase “further based on the default prompt” means that the subject is based on not only the AI and the field information but also the default prompt. For example, the generation-related processing execution module 202 inputs the input data including default prompt to the AI. The AI calculates the embedded representation based on not only the field information but also the default prompt. The embedded representation reflects not only the field information but also the default prompt. The AI outputs the output data including the storage data corresponding to the calculated embedded representation. The generation-related processing execution module 202 acquires the storage data included in the output data output by the AI. For example, the AI identifies what kind of storage data is to be generated based on the embedded representation corresponding to the default prompt, and generates storage data.

The generation-related processing in Modification Example 3 is not limited to the processing for generating storage data further based on the default prompt. The generation-related processing in Modification Example 3 may be other processing as in the at least one embodiment. For example, the generation-related processing execution module 202 may execute the generation-related processing by generating data such as a CSV file further based on the default prompt and importing the data into the app. The generation-related processing execution module 202 may execute the generation-related processing by generating an API request for requesting at least one of the generation or the storage of storage data further based on the default prompt. The generation-related processing execution module 202 may execute the generation-related processing by generating code for generating storage data further based on the default prompt.

The work support system 1 according to Modification Example 3 executes the generation-related processing further based on the default prompt. This enables the work support system 1 to execute the generation-related processing after supplementing a missing item in the input of the user with the default prompt. For example, even when the user does not input a data format in which the storage data is to be generated by the AI, the work support system 1 defines a specific data format by the default prompt, to thereby be able to generate storage data in the data format. Even when the work support system 1 does not acquire user input information, the work support system 1 can execute the generation-related processing after supplementing a missing item with the default prompt.

### 6-4. Modification Example 4

For example, appropriate storage data may differ depending on the user. For that reason, user attribute information relating to the attributes of the user may be input to the AI. The work support system 1 according to Modification Example 4 includes the user attribute information acquisition module 206. The user attribute information acquisition module 206 acquires the user attribute information relating to the attributes of the user. The user attribute information is information that enables classification of the user. Examples of the user attribute information may include the organization, organization size, department, job position, industry, profile, year of joining the company, age, gender, and other information of the user. The user attribute information may be information called demographic information.

In Modification Example 4, a case in which the data storage unit 300 of the work support server 30 stores a user database that stores the user attribute information is taken as an example. The user attribute information acquisition module 206 acquires the user attribute information from the user database. The user attribute information acquisition module 206 may acquire the user attribute information from another database other than the user database, another computer (for example, the generation-related server 20) other than the work support server 30, or an external information storage medium. The user may be able to edit his or her own user attribute information.

The generation-related processing execution module 202 in Modification Example 4 executes the generation-related processing further based on the user attribute information. The phrase “further based on the user attribute information” means that the subject is based on not only the AI and the field information but also the user attribute information. For example, the generation-related processing execution module 202 inputs the input data including the user attribute information to the AI. The AI calculates the embedded representation based on not only the field information but also the user attribute information. The embedded representation reflects not only the field information but also the feature of the user attribute information. The AI outputs the output data including storage data corresponding to the calculated embedded representation. The generation-related processing execution module 202 acquires the storage data included in the output data output by the AI, to thereby generate storage data corresponding to the user attribute information.

The generation-related processing in Modification Example 4 is not limited to the processing for generating storage data further based on the user attribute information. The generation-related processing in Modification Example 4 may be other processing as in the at least one embodiment. For example, the generation-related processing execution module 202 may execute the generation-related processing by generating data such as a CSV file further based on the user attribute information and importing the data into the app. The generation-related processing execution module 202 may execute the generation-related processing by generating an API request for requesting at least one of the generation or the storage of storage data further based on the user attribute information. The generation-related processing execution module 202 may execute the generation-related processing by generating code for generating storage data further based on the user attribute information.

The work support system 1 according to Modification Example 4 executes the generation-related processing further based on the user attribute information. This enables the work support system 1 to generate storage data corresponding to the attributes of the user. For example, when storage data suitable for a user belonging to a large company and storage data suitable for a user belonging to a small-to-medium company are different from each other, the work support system 1 can generate storage data corresponding to the size of the organization to which the user belongs. When storage data suitable for a user who works in a food and beverage industry and storage data suitable for a user who works in an apparel industry are different from each other, the work support system 1 can generate storage data corresponding to the industry in which the user works.

### 6-5. Modification Example 5

For example, in a case in which storage data of a certain app is to be generated, when there is a related app relating to the app, related data stored in the related app may serve as a reference. For that reason, the related data may be input to the AI. The work support system 1 according to Modification Example 5 includes the related data acquisition module 207. The related data acquisition module 207 acquires the related data stored in the related app relating to the app.

The related app is another app relating to the app in which the storage data is to be stored. It is assumed that app relationship data indicating a relationship between the app in which the storage data is to be stored (the app currently displayed on the work support screen SC in the examples of FIG. 2 and FIG. 3) and the related app is stored in the data storage unit 200. For example, the related app is another app having the same or similar usage purpose as the app in which the storage data is to be stored. The related app may be another app that can be referred to by the app in which the storage data is to be stored. In the app relationship data, the app ID of the app in which the storage data is to be stored and the app ID of the related app may be associated with each other. The related data acquisition module 207 identifies the related app based on the app relationship data.

The related data is all or some of records of the related app. When data other than the records is stored in the related app, the related data may be the other data. In Modification Example 5, the related data is assumed to be stored in the work support database DB. The related data acquisition module 207 identifies the app ID of the related app based on the app ID of the app selected by the user and the app relationship data. The related data acquisition module 207 requests the work support server 30 for the related data of the related app. The request is assumed to include the app ID of the related app.

For example, when the work support server 30 receives the request, the work support server 30 refers to the work support database DB to acquire the related data associated with the app ID. The related data may be all or some of the records of the related app. The work support server 30 transmits the related data to the generation-related server 20. The related data acquisition module 207 acquires the related data from the work support server 30. The related app may not be identified by the generation-related server 20, but may be identified by the work support server 30. In this case, the data storage unit 300 stores the app relationship data. It suffices that the work support server 30 acquires the app ID of the app in which the storage data is to be stored from the generation-related server 20, and identifies the related app based on the app ID and the app relationship data.

The generation-related processing execution module 202 in Modification Example 5 executes the generation-related processing further based on the related data. The phrase “further based on the related data” means that the subject is based on not only the AI and the field information but also the related data. For example, the generation-related processing execution module 202 inputs the input data including the related data to the AI. The AI calculates the embedded representation based on not only the field information but also the related data. The embedded representation reflects not only the field information but also the related data. The AI outputs the output data including the storage data corresponding to the calculated embedded representation. The generation-related processing execution module 202 acquires the storage data included in the output data output by the AI. For example, the AI identifies what kind of storage data is to be generated based on the embedded representation corresponding to the related data, and generates storage data.

The generation-related processing in Modification Example 5 is not limited to the processing for generating storage data further based on the related data. The generation-related processing in Modification Example 5 may be other processing as in the at least one embodiment. For example, the generation-related processing execution module 202 may execute the generation-related processing by generating data such as a CSV file further based on the related data and importing the data into the app. The generation-related processing execution module 202 may execute the generation-related processing by generating an API request for requesting at least one of the generation or the storage of storage data further based on the related data. The generation-related processing execution module 202 may execute the generation-related processing by generating code for generating storage data further based on the related data.

The work support system 1 according to Modification Example 5 executes the generation-related processing further based on the related data. The work support system 1 can generate storage data specific to the related data. For example, the related data may serve as a reference for the app in which the storage data is to be stored. The work support system 1 can generate storage data using the related data as a reference by executing the generation-related processing based on the related data, thereby increasing the accuracy of the storage data. For example, in a case of such a meeting minutes management app as in FIG. 2 and FIG. 3, there is a possibility that records of an in-house document management app, which has the same usage purpose of managing documents, may serve as a reference. The work support system 1 can generate plausible storage data by executing the generation-related processing based on the related data of the in-house document management app serving as the related app.

### 6-6. Modification Example 6

For example, the work support system 1 may generate a plurality of pieces of storage data. Assuming that each individual record of the app corresponds to the storage data, three pieces of storage data have been generated due to three records that have been generated on the work support screen SC in the lower half of FIG. 3. In a case in which a plurality of pieces of storage data are to be generated, when the individual pieces of storage data are the same or similar to each other in terms of content thereof, there is no variation in the storage data, and significance of the generation of a plurality of pieces of storage data may be diminished. In view of this, in Modification Example 6, a case in which the storage data is provided with variation is described.

The generation-related processing execution module 202 in Modification Example 6 executes the generation-related processing relating to the generation of a plurality of pieces of storage data that are mutually different. The plurality of pieces of storage data that are mutually different are plurality of pieces of storage data that are not the same as each other or a plurality of pieces of storage data that are not similar to each other. The plurality of pieces of storage data that are not similar to each other are a plurality of pieces of storage data each difference between which is equal to or exceeds a standard. For example, a difference between numerical values being equal to or exceeding a threshold value corresponds to the difference therebetween being equal to or exceeding the standard. The number of mutually different characters being equal to or exceeding a threshold value corresponds to the difference therebetween being equal to or exceeding the standard. A difference between vectors indicating meanings in a natural language being equal to or exceeding a threshold value corresponds to the difference therebetween being equal to or exceeding the standard.

In Modification Example 6, it is assumed that the AI can, as an option thereof, set randomness to be given to the output data. For example, when the AI is GPT, a temperature parameter that affects the randomness of the output data is provided as a parameter of the API request. The temperature parameter is indicated by a numerical value in a predetermined range (for example, 0 to 2). As the temperature parameter becomes higher, the output data becomes more random. As the temperature parameter becomes lower, the output data becomes more fixed.

There may be a similar parameter in another AI other than GPT. The parameter may be a publicly-known parameter. For example, in a case of using another AI other than GPT, the storage data may be provided with variation through adjustment of a parameter called diversity or diversity penalty. A parameter adjustment method may be a publicly-known method employed in an AI. The parameter may be adjusted by an administrator of the work support system 1, or may be adjusted by the user. The parameter for providing variation to the storage data is assumed to be stored in the data storage unit 200.

For example, the generation-related processing execution module 202 executes the generation-related processing by transmitting the API request including the input data to the external system managing the AI. The API request includes a temperature parameter. The temperature parameter may be any value, and in Modification Example 6, the temperature parameter is assumed to be larger than a default value (for example, 1). However, when the temperature parameter is too large, there is a possibility that the output data may be indefinite, and hence the temperature parameter may be lower than a maximum value. For example, the temperature parameter may be larger than the default value and less than the maximum value. The temperature parameter may be held on the external system side. In this case, the temperature parameter held on the external system side may be changed in response to the request received from the work support system 1.

A method of generating a plurality of pieces of storage data that are mutually different is not limited to the above-mentioned example. For example, the generation-related processing execution module 202 may execute the generation-related processing based on the input data including a default prompt (for example, a default prompt such as “Please generate a plurality of pieces of storage data so as to differ from each other”) for instructing the AI to generate a plurality of pieces of storage data that are mutually different. The AI can recognize that a plurality of pieces of storage data that are mutually different are to be generated by such a default prompt. The AI calculates the embedded representation based on the input data including such a default prompt, and outputs the output data including the plurality of pieces of storage data corresponding to the embedded representation. The generation-related processing execution module 202 acquires the plurality of pieces of storage data included in the output data output from the AI.

The data storing module 302 in Modification Example 6 stores the plurality of pieces of storage data that are mutually different in the app. Modification Example 6 differs from the at least one embodiment in that a plurality of pieces of storage data generated so as to differ from each other are stored in the app, but the processing itself in which the data storing module 302 stores individual pieces of storage data in the app is the same as that in the at least one embodiment.

The work support system 1 according to Modification Example 6 executes the generation-related processing relating to the generation of a plurality of pieces of storage data that are mutually different. The work support system 1 stores the plurality of pieces of storage data that are mutually different in the app. This enables the work support system 1 to provide variation to a plurality of pieces of storage data to be generated through use of the AI. For example, when the user uses the storage data for the verification work at a time of extending the function of the app, the user can perform the verification work through use of a rich variety of storage data, and hence the work support system 1 can effectively support the verification work of the user.

### 6-7. Modification Example 7

For example, the user may designate the number of pieces of storage data to be generated in the input form F. Assuming that each individual record of the app corresponds to the storage data, the user may designate the number of records to be generated by the AI as the number of pieces of storage data to be generated. The user may designate the number of pieces of storage data to be generated by voice or the like without particularly using the input form F. At least one of an upper limit value or a lower limit value may be determined for the generation number that can be designated by the user. The user designates any generation number within a range of the generation number that can be designated by the user. The user may designate a rough generation number such as “more,” “less,” or “about 10” instead of a numerical value indicating the generation number. Even when such an instruction is given, the AI may be able to recognize roughly how many pieces of storage data are to be generated.

The work support system 1 according to Modification Example 7 includes the generation number information acquisition module 208. The generation number information acquisition module 208 acquires, based on the input of the user, generation number information relating to the number of pieces of storage data to be generated. The generation number information indicates the generation number designated by the user. For example, when the user designates the generation number, the user terminal 40 transmits the generation number information to the generation-related server 20. The generation number information acquisition module 208 acquires the generation number information from the user terminal 40. When the user defines the generation number in advance, the generation number information may be stored in the data storage unit 200. In this case, the generation number information acquisition module 208 acquires the generation number information from the data storage unit 200. When the generation number information is stored in another computer other than the generation-related server 20 or an external information storage medium, the generation number information acquisition module 208 may acquire the generation number information from the other computer or the external information storage medium.

The generation-related processing execution module 202 in Modification Example 7 executes the generation-related processing further based on the generation number information. The phrase “further based on the generation number information” means that the subject is based on not only the AI and the field information but also the generation number information. For example, the generation-related processing execution module 202 inputs the input data including the generation number information to the AI. The AI calculates the embedded representation based on not only the field information but also the generation number information. The embedded representation reflects not only the field information but also the generation number information. The AI outputs the output data including the storage data corresponding to the calculated embedded representation. The generation-related processing execution module 202 acquires the storage data included in the output data output by the AI. For example, the AI determines how many pieces of storage data is to be generated based on the embedded representation corresponding to the generation number information, and generates storage data.

The generation-related processing in Modification Example 7 is not limited to the processing for generating storage data further based on the generation number information. The generation-related processing in Modification Example 7 may be other processing as in the at least one embodiment. For example, the generation-related processing execution module 202 may execute the generation-related processing by generating data such as a CSV file further based on the generation number information and importing the data into the app. The generation-related processing execution module 202 may execute the generation-related processing by generating an API request for requesting at least one of the generation or the storage of storage data further based on the generation number information. The generation-related processing execution module 202 may execute the generation-related processing by generating code for generating storage data further based on the generation number information.

The work support system 1 according to Modification Example 7 executes the generation-related processing further based on the generation number information. This enables the work support system 1 to generate storage data the number of pieces of which is a number desired by the user or a number close to the desired number, thereby being able to further increase the convenience of the user. For example, when the user uses the storage data for the verification work at the time of extending the function of the app, the user can perform the verification work through use of an appropriate number of pieces of storage data, and hence the work support system 1 can effectively support the verification work of the user.

### 6-8. Modification Example 8

For example, the generation-related processing execution module 202 may execute the generation-related processing relating to the generation of storage data that is part of a record of the app. The generation-related processing execution module 202 in Modification Example 8 executes the generation-related processing not relating to the generation of storage data indicating all items of the record of the app but relating to the generation of storage data indicating some of the items. For example, the generation-related processing execution module 202 executes generation-related processing for generating specific values of fields among the items relating to the record of the app. Items that are not to be included in the storage data are generated without using the AI.

For example, the generation-related processing execution module 202 executes the generation-related processing relating to the generation of storage data indicating items other than a record number assigned based on a numbering rule defined in advance and creation date and time of the record, as which the date and time at that time are used. The generation-related processing execution module 202 generates actual data of the record including the storage data generated through use of the AI, the record number assigned based on the numbering rule defined in advance, and the creation date and time of the record, which is the date and time at that time. Items that are not to be included in the storage data (that is, items to be generated without using the AI) may be provided in advance. When the generation-related processing execution module 202 dynamically generates items that are not to be included in the storage data (in the above-mentioned example, the record number and the creation date and time) on the spot, the items are only required to be generated based on a program provided in advance.

The data storing module 302 in Modification Example 8 stores, in the app, the record including the storage data as part thereof. For example, the data storing module 302 stores, in the app, the actual data of the record including the storage data, the record number assigned based on the numbering rule defined in advance, and the creation date and time of the record, which is the date and time at that time. Items that are not to be included in the storage data may be generated on the work support server 30 side.

The work support system 1 according to Modification Example 8 executes the generation-related processing relating to the generation of storage data that is part of the record of the app. The work support system 1 stores, in the app, the record including the storage data as part thereof. In this manner, the work support system 1 generates a record through selective use of part that is appropriate for generation using the AI and part that is not, thereby being able to increase accuracy of the generation of a record.

### 6-9. Modification Example 9

For example, the AI may not be able to generate storage data that meets the wish of the users at once. For that reason, the user may be able to give an instruction to correct the storage data generated by the AI. In the examples of FIG. 2 and FIG. 3, the user may give an instruction to correct the storage data generated by the AI from the work support screen SC in the lower half of FIG. 3. In Modification Example 9, a case in which the user gives an instruction to correct the storage data by voice input is taken as an example, but the user may give an instruction to correct the storage data by any other input method. For example, the user may give an instruction to correct the storage data by text input.

The user may explicitly instruct the work support system 1 to correct the storage data by voice input, text input, or another operation (for example, by selecting a “Correct” button). The work support system 1 can identify, based on the explicit instruction from the user, that the generated storage data is to be corrected rather than new storage data is to be generated. Even when the user does not give an explicit instruction, the AI may infer that the storage data is to be corrected. The AI may identify, based on the input data, that the generated storage data is to be corrected rather than new storage data is to be generated. The AI can perform such identification through use of the embedded representation of the input data.

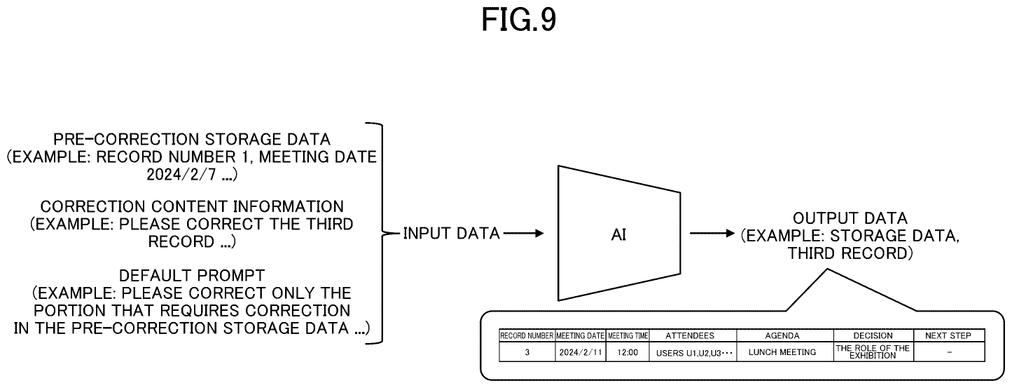

FIG. 9 is a diagram for illustrating an example of processing for the correction of the storage data. The work support system 1 according to Modification Example 9 includes the correction content information acquisition module 209, the correction-related processing execution module 210, and the storage data correction module 211. The correction content information acquisition module 209 acquires correction content information relating to correction content of the storage data based on the input of the user. The correction content information is an instruction indicated by the input of the user at a time of the correction of the storage data. The correction content information can also be said to be the intention of the user at the time of the correction. The correction content information may also be called a prompt for the AI. As in FIG. 9, at the time of the correction, the input data including the correction content information is input to the AI.

In Modification Example 9, a case in which text input in the input form F when the user selects the button B at the time of the correction of the storage data corresponds correction content information is taken as an example. Thus, the correction content information is text indicating specific content with which the user wishes to correct the storage data. When the user selects the button B, the user terminal 40 transmits the correction content information, which is the text input in the input form F, to the generation-related server 20. The correction content information acquisition module 209 acquires s the correction content information from the user terminal 40. The correction content information acquisition module 209 may acquire only one piece of correction content information, or may acquire a plurality of pieces of correction content information.

The correction content information may not be text in a natural language but may be the voice itself that has been used in the input by the user. In this case, the correction content information acquisition module 209 may acquire the correction content information, which is the voice, from the user terminal 40 and then request the voice conversion server 10 to convert the correction content information into text. The correction content information acquisition module 209 acquires the correction content information converted into text from the voice conversion server 10. The correction content information acquisition module 209 may acquire the correction content information indirectly through the voice conversion server 10, the work support server 30, or another computer, instead of acquiring the correction content information directly from the user terminal 40.

The correction-related processing execution module 210 executes correction-related processing relating to generation of correction portion data, which is post-correction data of a correction portion corresponding to the correction content in the storage data, based on the correction content information and the AI. The correction portion corresponding to the correction content is a portion in the pre-correction storage data. An amount of the correction portion varies depending on the correction content. For example, the correction portion may be only one record, or may be two or more records. The correction portion may not be a certain set of consecutive records. For example, the third and tenth records of the storage data having 20 records may be the correction portions. Which portion is to be corrected is determined by the AI. The correction portion may be only some items of one record.

For example, the AI outputs, together with the correction portion data, correction portion identification information that can identify the correction portion in the pre-correction storage data. The correction portion identification information can also be said to be a location of the correction portion in the pre-correction storage data. For example, the correction portion identification information indicates which record the correction portion is on. As the default prompt at the time of the correction, a prompt such as “Please correct only the portion that requires correction in the pre-correction storage data. Please output the post-correction correction portion data of that portion and the identification information on that portion.” may be provided. Such a default prompt enables the AI to more accurately understand that it is only required to output the correction portion data and d the correction portion identification information.

For example, the correction-related processing execution module 210 inputs the input data including the pre-correction storage data and the correction content information to the AI. In the example of FIG. 9, the correction-related processing execution module 210 inputs the input data further including the default prompt to the AI. The AI calculates the embedded representation based on not only the correction content information but also the pre-correction storage data. The embedded representation reflects not only the correction content information but also the pre-correction storage data. The AI outputs the output data including the correction portion identification information and the correction portion data corresponding to the calculated embedded representation. The correction-related processing execution module 210 acquires the correction portion data and the correction portion identification information included in the output data output by the AI. In the example of FIG. 9, only the portion of the third record of the pre-correction storage data is output from the AI as the correction portion data. The correction portion identification information indicates that the correction portion is on the third record.

The storage data correction module 211 corrects the storage data by replacing the correction portion in the storage data by the correction portion data. The replacement can also be said to be overwriting or change. In the example of FIG. 9, the third record of the pre-correction storage data is replaced by the correction portion data. For example, the storage data correction module 211 replaces the correction portion indicated by the correction portion identification information in the pre-correction storage data by the correction portion data. The user may designate the correction portion. For example, the user may perform input such as “Please correct the third record.” In this case, the correction content information includes the correction portion identification information. The AI is not required to output the correction portion identification information. Even when the AI does not output the correction portion identification information, the storage data correction module 211 is only required to replace the correction portion input by the user by the correction portion data.

The work support system 1 according to Modification Example 9 acquires the correction content information based on the input of the user. The work support system 1 executes correction-related processing relating to generation of correction portion data in the storage data based on the correction content information and the AI. The work support system 1 corrects the storage data by replacing the correction portion in the storage data by the correction portion data. This enables the work support system 1 to increase the efficiency of a correction task for the storage data performed by the user, thereby increasing the convenience of the user at the time of the correction. For example, when the AI regenerates the entire storage data, there is a possibility that storage data indicating completely different processing from before the correction may be generated, but the work support system 1 replaces only the correction portion in the pre-correction storage data by the correction portion data, thereby preventing the storage data from becoming completely different storage data from before the correction, for example, and increasing accuracy of the correction.

### 6-10. Modification Example 10

In the at least one embodiment, the case in which storage data is generated in order for the user to verify an extension function of the app has been taken as an example. When the user communicates verification content of the verification work to be performed to an AI, the AI may be able to generate storage data corresponding to the verification content. In view of this, in Modification Example 10, a case in which verification content information is used is taken as an example.

The work support system 1 according to Modification Example 10 includes the verification content information acquisition module 212. The verification content information acquisition module 212 acquires the verification content information relating to the verification content of the app. The verification content information is specific content of the work support function to be verified by the user. In Modification Example 10, the verification content information indicates content of the extension of the function performed by the user. The verification content information can also be said to be a purpose for which storage data is to be generated. The verification content information is sometimes called a prompt with respect to the AI. When the AI is a large language model, the verification content information is written in a natural language so that the AI can understand the verification content.

The verification content information may be the text input by the user in the input form F at a time of generating storage data, but in Modification Example 10, a case in which the verification content information acquisition module 212 acquires text input by the user in the input form F in the past as the verification content information is taken as an example. For example, in the examples of FIG. 2 and FIG. 3, the user had input content of the function to be extended in advance (for example, content such as “Turn the record with the oldest meeting date green”) in the input form F before the generation of storage data was instructed. The verification content information acquisition module 212 acquires text indicating content input in the past as the verification content information. The content input in the past may be stored in the data storage unit 200. The verification content information may be a task of the user for that day and the like instead of the content input in the input form F by the user. In this case, the verification content information acquisition module 212 acquires the verification content information from a database in which tasks of the user and the like are managed.

The generation-related processing execution module 202 in Modification Example 10 executes the generation-related processing further based on the verification content information. The phrase “further based on the verification content information” means that the subject is based on not only the AI and the field information but also the verification content information. For example, the generation-related processing execution module 202 inputs the input data including the verification content information to the AI. The AI calculates the embedded representation based on not only the field information but also the verification content information. The embedded representation reflects not only the field information but also the verification content information. The AI outputs the output data including the storage data corresponding to the calculated embedded representation. The generation-related processing execution module 202 acquires the storage data included in the output data output by the AI. For example, the AI identifies what kind of storage data is to be generated based on the embedded representation corresponding to the verification content information, and generates storage data.

The generation-related processing in Modification Example 10 is not limited to the processing for generating storage data further based on the verification content information. The generation-related processing in Modification Example 10 may be other processing as in the at least one embodiment. For example, the generation-related processing execution module 202 may execute the generation-related processing by generating data such as a CSV file further based on the verification content information and importing the data into the app. The generation-related processing execution module 202 may execute the generation-related processing by generating an API request for requesting at least one of the generation or the storage of storage data further based on the verification content information. The generation-related processing execution module 202 may execute the generation-related processing by generating code for generating storage data further based on the verification content information.

The work support system 1 according to Modification Example 10 executes the generation-related processing further based on the verification content information. This enables the work support system 1 to generate storage data specific to the verification content information. For example, when the user verifies the extension of the function of the app, the work support system 1 can generate storage data corresponding to the verification content, thereby being able to effectively support the verification work of the user.

### 6-11. Other Modification Examples

For example, two or more of Modification Examples 1 to 10 may be combined.

For example, the functions described as being implemented by the voice conversion server 10 may be implemented by the generation-related server 20, the work support server 30, or the user terminal 40. The functions described as being implemented by the generation-related server 20 may be implemented by the voice conversion server 10, the work support server 30, or the user terminal 40. The functions described as being implemented by the work support server 30 may be implemented by the voice conversion server 10, the generation-related server 20, or the user terminal 40. The functions described as being implemented by the user terminal 40 may be implemented by the voice conversion server 10, the generation-related server 20, or the work support server 30. The respective functions may be distributed to a plurality of computers, or may be implemented by a single computer.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A work support system, which is configured to support work of a user through use of a database designed with no-code or low-code, the work support system comprising at least one processor configured to:
acquire field information relating to each field of the database;
execute, based on the field information and an AI, generation-related processing relating to generation of storage data to be stored in the database; and
store the storage data in the database.

2. The work support system according to claim 1, wherein the at least one processor is configured to:
acquire information relating to the database, the information being information other than the field information; and
execute the generation-related processing further based on the other information.

3. The work support system according to claim 1, wherein the at least one processor is configured to:
acquire specification information relating to a specification in the work support system; and
execute the generation-related processing further based on the specification information.

4. The work support system according to claim 1, wherein the at least one processor is configured to:
acquire a default prompt relating to generation of the database, the default prompt being provided in advance; and
execute the generation-related processing further based on the default prompt.

5. The work support system according to claim 1, wherein the at least one processor is configured to:
acquire user attribute information relating to an attribute of the user; and
execute the generation-related processing further based on the user attribute information.

6. The work support system according to claim 1, wherein the at least one processor is configured to:
acquire related data stored in a related database relating to the database; and
execute the generation-related processing further based on the related data.

7. The work support system according to claim 1, wherein the at least one processor is configured to:
execute the generation-related processing relating to generation of a plurality of pieces of the storage data that are mutually different; and
store the plurality of pieces of the storage data that are mutually different in the database.

8. The work support system according to claim 1, wherein the at least one processor is configured to:
acquire, based on input of the user, generation number information relating to the number of pieces of the storage data to be generated; and
execute the generation-related processing further based on the generation number information.

9. The work support system according to claim 1, wherein the at least one processor is configured to:
execute the generation-related processing relating to the generation of the storage data that is part of a record of the database; and
store, in the database, the record including the storage data as the part.

10. The work support system according to claim 1, wherein the at least one processor is configured to:
acquire, based on input of the user, correction content information relating to correction content in the storage data;
execute correction-related processing relating to generation of correction portion data, which is post-correction data of a correction portion corresponding to the correction content in the storage data, based on the correction content information and the AI; and
correct the storage data by replacing the correction portion in the storage data by the correction portion data.

11. The work support system according to claim 1, wherein the at least one processor is configured to:
acquire verification content information relating to verification content of the database; and
execute the generation-related processing further based on the verification content information.

12. A work support method for supporting work of a user through use of a database designed with no-code or low-code, the work support method comprising:
acquiring field information relating to each field of the database;
executing, based on the field information and an AI, generation-related processing relating to generation of storage data to be stored in the database; and
storing the storage data in the database.

13. A non-transitory information storage medium having stored thereon a program for causing a computer configured to support work of a user through use of a database designed with no-code or low-code to:
acquire field information relating to each field of the database;
execute, based on the field information and an AI, generation-related processing relating to generation of storage data to be stored in the database; and
store the storage data in the database.
